(19) United States
(12) Patent Application Publication
(10) Pub. No.: US 2008/0304025 A1
(43) Pub. Date: Dec. 11, 2008

(54) APPARATUS AND METHOD FOR IMMERSION LITHOGRAPHY

(75) Inventors: Ching-Yu Chang, Yilang County (TW); Burn Jeng Lin, Hsin-Chu (TW)

Correspondence Address: HAYNES AND BOONE, LLP, 901 Main Street, Suite 3100, Dallas, TX, 75202, US

(73) Assignee: TAIWAN SEMICONDUCTOR MANUFACTURING COMPANY, LTD., Hsin-Chu (TW)

(21) Appl. No.: 11/760,365

(22) Filed: Jun. 8, 2007

(51) Int. Cl. G03B 27/42

(52) U.S. Cl. 355/30; 355/77

(57) ABSTRACT

An immersion lithography apparatus includes a lens assembly having an imaging lens, a wafer stage for securing a wafer beneath the lens assembly, a fluid module for providing a fluid into a space between the lens assembly and the wafer, and a plurality of extraction units positioned proximate to an edge of the wafer. The extraction units are configured to operate independently to remove a portion of the fluid provided into the space between the lens assembly and the wafer.

### BACKGROUND

The present disclosure relates generally to immersion lithography and, more particularly, to an apparatus and method for independently controlling a plurality of extraction lines located proximate to an edge of a wafer during immersion lithography.

As semiconductor fabrication technologies are continually progressing to smaller feature sizes such as 65 nanometers, 45 nanometers, and below, immersion lithography methods are being adopted. Immersion lithography is an advancement in photolithography, in which the exposure procedure is performed with an immersion fluid filling the space between the surface of the wafer and the lens. Using immersion lithography, higher numerical apertures can be built than when using lenses in air, resulting in improved resolution. Further, immersion lithography provides enhanced depth-of-focus (DOF) for printing ever smaller features. During processing, extraction or drain lines located proximate to an edge of the wafer provide a suck back force to remove the immersion fluid as well as particles at the edge of the wafer. However, there may be instances when the immersion fluid does not cover an area around the edge of the wafer. Accordingly, an evaporation phenomena is stronger at the edge of the wafer as compared to the center of the wafer. This can cause a temperature variance on the surface of wafer which may adversely affect the immersion lithography process.

Therefore, what is needed is a simple and cost-effective apparatus and method for independently controlling the extraction lines at the edge of the wafer so as to minimize the temperature variance on the surface of the wafer.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of an immersion lithography system.

FIGS. 2A and 2B are cross-sectional views of part of the immersion lithography system of FIG. 1 performing an immersion lithography process.

FIGS. 3A and 3B are top and cross-sectional views, respectively, of a wafer edge extraction line design according to one or more embodiments of the present disclosure.

FIGS. 4A and 4B are cross-sectional views of an immersion lithography process utilizing the wafer edge extraction line design of FIGS. 3A and 3B.

FIG. 5 is a flowchart for an immersion lithography process according to one or more embodiments of the present disclosure.

### DETAILED DESCRIPTION

The present disclosure relates generally to the liquid immersion photolithography systems, and, more particularly, to an immersion photolithography system using a sealed wafer bottom. It is understood, however, that specific embodiments are provided as examples to teach the broader inventive concept, and one of ordinary skill in the art can easily apply the teachings of the present disclosure to other methods and systems. Also, it is understood that the methods and systems discussed in the present disclosure include some conventional structures and/or steps. Since these structures and steps are well known in the art, they will only be discussed in a general level of detail. Furthermore, reference numbers are repeated throughout the drawings for the sake of convenience and example, and such repetition does not indicate any required combination of features or steps throughout the drawings.

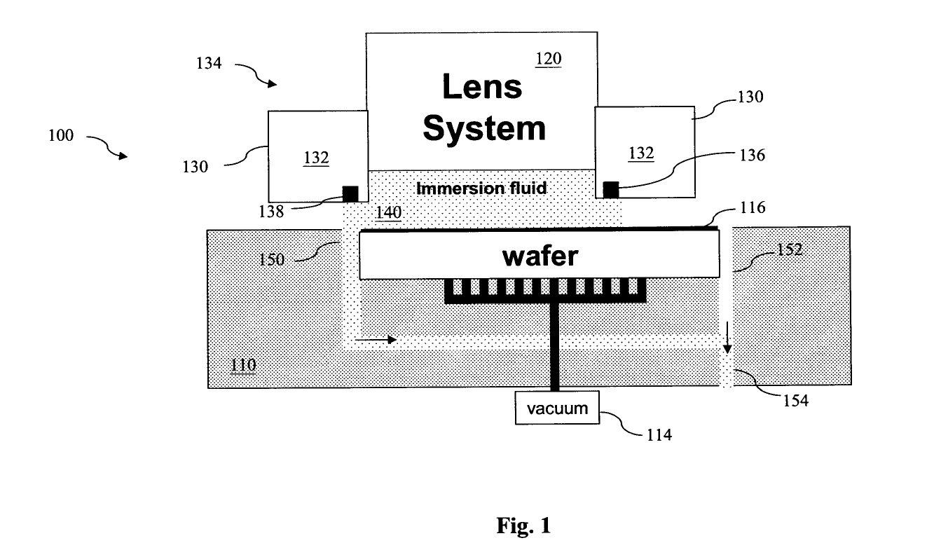

Referring to FIG. 1, illustrated is a schematic view of an immersion lithography system 100. The system 100 may include a wafer table 110 for holding a wafer 112 to be processed by the system 100. The wafer table 110 can be a wafer stage or include a wafer stage as a part thereof. The wafer table 110 is operable to secure and move the wafer 112 relative to the system 100. For example, the wafer table 110 may secure the wafer 112 via a vacuum chuck 114. The wafer table 110 may also be capable of translational and/or rotational displacement for wafer alignment, stepping, and scanning. The wafer table 110 may include various components suitable to perform precise movement.

The wafer 112 to be held by the wafer table 110 and processed by the system 100 may be a semiconductor wafer (or substrate) such as a silicon wafer. Alternatively, the semiconductor wafer may include an elementary semiconductor, a compound semiconductor, an alloy semiconductor, or combinations thereof. The semiconductor wafer may include one or more material layers such as poly-silicon, metal, and/or dielectric, to be patterned. The wafer 112 may further include an imaging layer 116 formed thereon. The imaging layer 116 can be a photoresist layer (resist layer, photosensitive layer, patterning layer) that is responsive to an exposure process for creating patterns. The imaging layer 116 may be a positive or negative type resist material and may have a multi-layer structure. One exemplary resist material is chemical amplifier (CA) resist.

The immersion lithography system 100 may further include one or more imaging lens assemblies or systems (referred to as a “lens system”) 120. The semiconductor wafer may be positioned on a wafer table 110 under the lens system 120. The lens system 120 may further include or be integral to an illumination system (e.g., a condenser) which may have a single lens or multiple lenses and/or other lens components. For example, the illumination system may include microlens arrays, shadow masks, and/or other structures. The lens system 120 may further include an objective lens which may have a single lens element or a plurality of lens elements. Each lens element may include a transparent substrate and may further include a plurality of coating layers. The transparent substrate may be a conventional objective lens, and may be made of fused silica (SiO2), calcium-fluoride (CaF2), lithium fluoride (LiF), barium fluoride (BaF2), or other suitable material. The materials used for each lens element may be chosen based on the wavelength of light used in the lithography process to minimize absorption and scattering.

The system 100 may also include an immersion fluid retaining module 130 for holding a fluid 132 such as an immersion fluid. The immersion fluid retaining module 130 may be positioned proximate (such as around) the lens system 120 and designed for other functions, in addition to holding the immersion fluid. The immersion fluid retaining module 130 and the lens system 120 may make up (at least in part) an immersion hood 134. The immersion fluid may include water (water solution or de-ionized water (DIW)), high n fluid (n is index of refraction, the n value at 193 nm wavelength here is larger than 1.44), gas, or other suitable fluid.

The immersion fluid retaining module 130 may include various apertures (or nozzles) for providing the immersion fluid for an exposure process. Particularly, the module 130 may include an aperture 136 as an immersion fluid inlet to provide and transfer the immersion fluid into a space 140 between the lens system 120 and the wafer 112 on the wafer table 110. The module 130 may also include an aperture 138 as an immersion fluid outlet to remove and transfer the immersion fluid from the space 140. It is understood that the immersion fluid may be provided to and from the space 140 at a sufficient rate by components suitable for this type of movement. Additionally, the immersion fluid outlet may be part of a drain system for removing the immersion fluid from the immersion lithography system 100.

The drain system may further include a plurality of extraction (or suck back) lines 150, 152 located proximate to an edge of the wafer 112 for removing a portion of the immersion fluid provided to the space 140 between the lens system 120 and the wafer 112 on the wafer table 110. The extraction lines 150, 152 may merge into a single line 154 that provides a such back force to remove the immersion fluid from the system. The extraction lines 150, 152 may be incorporated or integrated with the wafer table 110. It is understood that the number of extraction lines may vary and will depend on the type of immersion lithography system that is used.

The immersion lithography system 100 may further include a radiation source (not shown). The radiation source may be a suitable ultraviolet (UV) or extreme ultraviolet (EUV) light source. For example, the radiation source may be a mercury lamp having a wavelength of 436 nm (G-line) or 365 nm (I-line); a Krypton Fluoride (KrF) excimer laser with wavelength of 248 nm; an Argon Fluoride (ArF) excimer laser with a wavelength of 193 nm; a Fluoride (F2) excimer laser with a wavelength of 157 nm; an extreme ultraviolet (EUV) light source with a wavelength of 13.5 nm; or other light sources having a desired wavelength (e.g., below approximately 100 nm).

A photomask (also referred to as a mask or a reticle) may be introduced into the system 100 during an immersion lithography process. The mask may include a transparent substrate and a patterned absorption layer. The transparent substrate may use fused silica (SiO2) relatively free of defects, such as borosilicate glass and soda-lime glass. The transparent substrate may use calcium fluoride and/or other suitable materials. The patterned absorption layer may be formed using a plurality of processes and a plurality of materials, such as depositing a metal film made with chromium (Cr) and iron oxide, or an inorganic film made with MoSi, ZrSiO, SiN, and/or TiN.

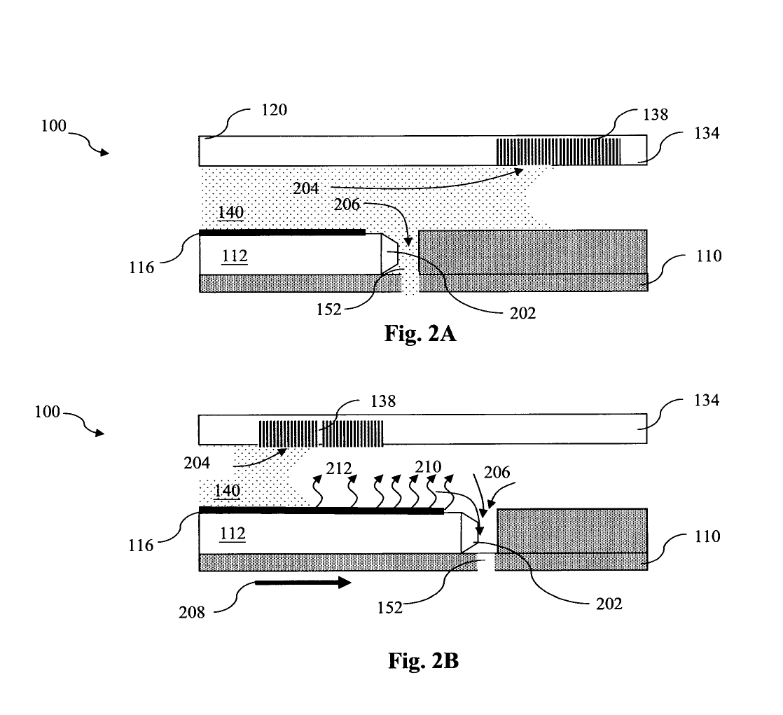

Referring now also to FIGS. 2A and 2B, illustrated are cross-sectional views of part of the immersion lithography system 100 of FIG. 1 performing an immersion lithography process. In FIG. 2A, the wafer 112 having the imaging layer 116 formed thereon may be secured on the wafer table 110. During the immersion lithography process, the wafer table 110 may be moved so that an area of the imaging layer 116 to be exposed (e.g., exposure field or exposure die area) is aligned with the lens system 120 of the immersion hood 134. The system 100 may be operable according to a particular recipe setting which specifies various parameters such as exposure time and location coordinates for the immersion lithography process. The immersion fluid may be provided to the space 140 between the lens system 120 and the surface of the wafer 112. The immersion fluid may substantially cover an area under the lens system 120.

In the present example, the area of the imaging layer 116 to be exposed is near an edge 202 of the wafer 112. Accordingly, the immersion fluid may cover the edge 202 of the wafer 112 and may be removed 204, 206 from the space 140 via the immersion fluid outlet 138 of the immersion hood 134 and/or the extraction line 152 located proximate to the edge 202 of the wafer 112. An exposure process may be performed to pattern the area of the imaging layer 116.

In FIG. 2B, the wafer table 110 may be moved 208 to a next location so that a next area of the imaging layer 116 can be exposed. In this example, the next area of the imaging layer 116 to be exposed is away from the edge 202 of the wafer 112. The immersion fluid may be provided to the space 140 between lens system 120 and the surface of the wafer 112. The immersion fluid substantially covers the area under the lens system 120 of the immersion hood 134. Accordingly, the immersion fluid does not cover the edge 202 of the wafer 112 that is proximate to the extraction line 152. The immersion fluid may be removed 204 via the immersion fluid outlet 138 of the immersion hood 134. The extraction line 152 proximate to the edge 202 of the wafer 112 continues to provide a suck back force 206.

However, one of the problems associated with the immersion lithography system 100 described above includes the fact that the extraction lines 150, 152 (FIG. 1) that are around the edge of the wafer provide a suck back force throughout the immersion lithography process. This is to ensure that particles, such as photoresist material, at the edge of the wafer may be removed before they contaminate the immersion fluid and/or immersion lithography system 100. As such, an evaporation phenomena 210 at the edge of the wafer may be stronger than an evaporation phenomena 212 at the center of the wafer. This can cause temperature variances on the imaging layer 116 of the wafer 112 (e.g., cooler temperatures at the edge) and may adversely affect a focus accuracy of the lens system 120 during the exposure process. The wafer edge/center focus difference may cause defects in critical dimensions (CD) and profiles of features patterned in the imaging layer 116 and thus, may lead to low yield and/or poor device performance.

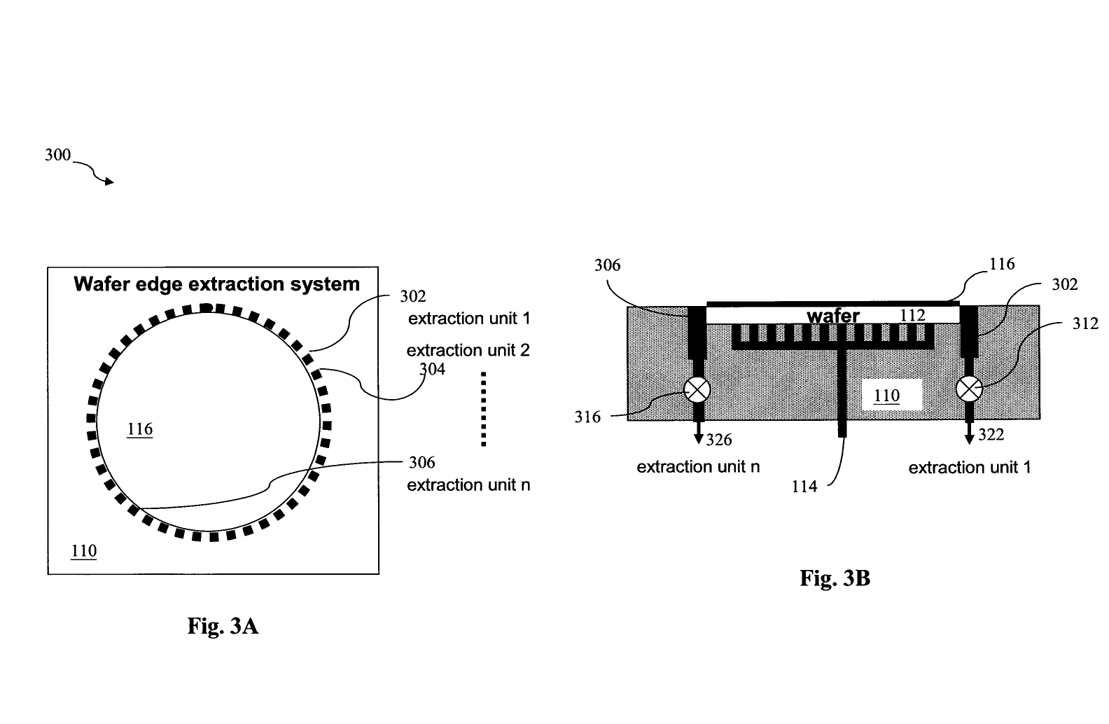

Referring now to FIGS. 3A and 3B, illustrated are a top view and cross-sectional view, respectively, of a wafer edge extraction system 300 according to one or more embodiments of the present disclosure. The wafer edge extraction system 300 may be utilized in the immersion lithography system 100 of FIG. 1. Similar components in FIGS. 1 and, 3A and 3B are numbered the same for the sake of simplicity and clarity. In FIGS. 3A and 3B, the wafer edge extraction system 300 includes a plurality of extraction units 302, 304, 306 (e.g., extraction unit 1, unit 2, . . . unit n) that are disposed proximate to and around an edge of the wafer 112. It is understood that the number of extraction units may vary and will depend on the design requirements of the immersion lithography system. The extraction units 302, 304, 306 may be incorporated or integrated with the wafer table 110. The extraction units 302, 304, 306 may be positioned and spaced uniformly around the edge of the wafer 112.

In FIG. 3B, each extraction unit 302, 306 includes a valve 312, 316 for controlling a suck back line or force 322, 326 for that unit. Even though all the extraction units are not shown in FIG. 3B, it is understood that all the extraction units in the wafer edge extraction system 300 may have its own control valve. In this way, the extraction units 302, 304, 306 may be configured to operate independently to turn on/off the suck back force for that unit. Alternatively, adjacent extraction units or extraction units in close proximity of each other may optionally share a valve. The valves 312, 316 may be controlled by a controller (not shown) via an electrical, mechanical, electromechanical, pneumatic, or other suitable mechanism.

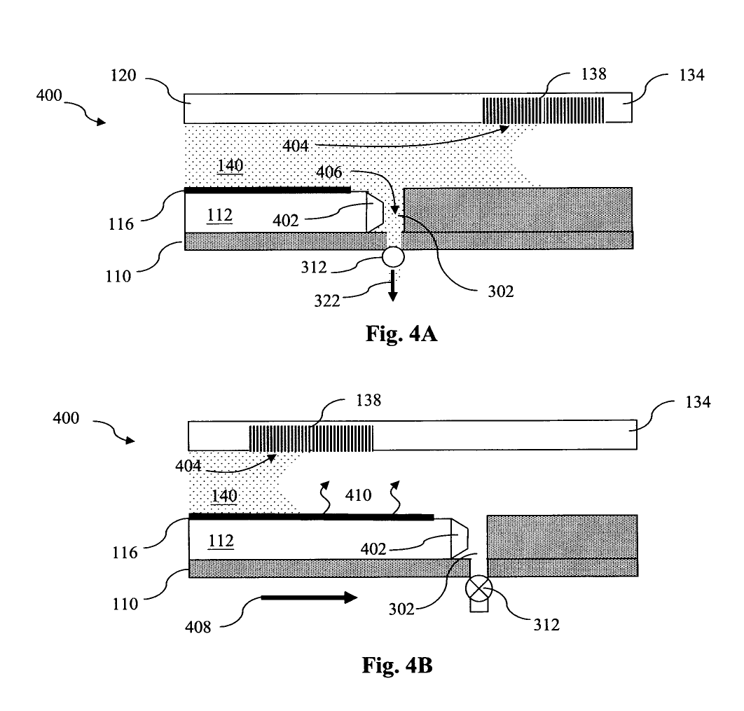

Referring now to FIGS. 4A and 4B, illustrated are cross-sectional views of part of an immersion lithography system 400 utilizing the wafer edge extraction system 300 of FIGS. 3A and 3B to perform an immersion lithography process. The immersion lithography system 400 is similar to the immersion lithography system 100 of FIG. 1. Similar components in FIGS. 1 and, 4A and 4B, are numbered the same for simplicity and clarity. In FIG. 4A, a wafer 112 having an imaging layer 116 formed thereon may be secured on a wafer table 110 via a vacuum chuck. During an immersion lithography process, the wafer table 110 may be moved so that an area of the imaging layer 116 to be exposed (e.g., exposure field or exposure die area) is aligned with the lens system 120 of the immersion hood 134. The immersion lithography system 400 may be operable according to a particular recipe setting which specifies various parameters such as exposure time and location coordinates for the immersion lithography process. The immersion fluid may be provided to the space 140 between the lens system 120 and the surface of the wafer 112. The immersion fluid may substantially cover an area under the lens system 120.

In the present example, an area of the imaging layer 116 to be exposed is near an edge 402 of the wafer 112. Accordingly, the immersion fluid is provided and may cover the edge 402 of the wafer 112. Some of the immersion fluid may be removed 404 from the space 140 via an immersion fluid outlet 138 of the immersion hood 134. Additionally, because the immersion fluid covers the edge 402 of the wafer 112, a controller (not shown) turns on a valve 312 of a corresponding extraction unit 302 that is proximate to the edge. The extraction unit 302 may provide a suck back force 322 to remove 406 a portion of the immersion fluid provided to the space 140. An exposure process may be performed to pattern the area of the imaging layer 116.

In FIG. 4B, the wafer table 110 may be moved 408 to a next location so that a next area of the imaging layer 116 can be exposed. In this example, the next area of the imaging layer 116 to be exposed is away from the edge 402 of the wafer 112. The immersion fluid may be provided to the space 140 between lens system 120 and the surface of the wafer 112. The immersion fluid substantially covers the area under the lens system 120 of the immersion hood 134. Accordingly, the immersion fluid does not cover the edge 402 of the wafer 112 that is proximate to the extraction unit 302. The immersion fluid may be removed 404 via the immersion fluid outlet 138 of the immersion hood 134.

Additionally, because the immersion fluid does not cover the edge 402, the controller may turn off the valve 312 of the corresponding extraction line 302 such that no suck back force is provided. By doing this, an evaporation phenomena 410 will be substantially uniform at the edge and towards the center of the wafer 112 where there is no immersion fluid. This will minimize a temperature variance of the imaging layer 116. Alternatively, the controller may control the extraction units according to a particular recipe setting. Since the recipe setting specifies an exposure field (or exposure die area) for the entire wafer, the controller may turn on the valve when the exposure field is proximate to an edge of the wafer and corresponding extraction unit, and turn off the valve when the exposure filed is away from the edge of the wafer and corresponding extraction unit.

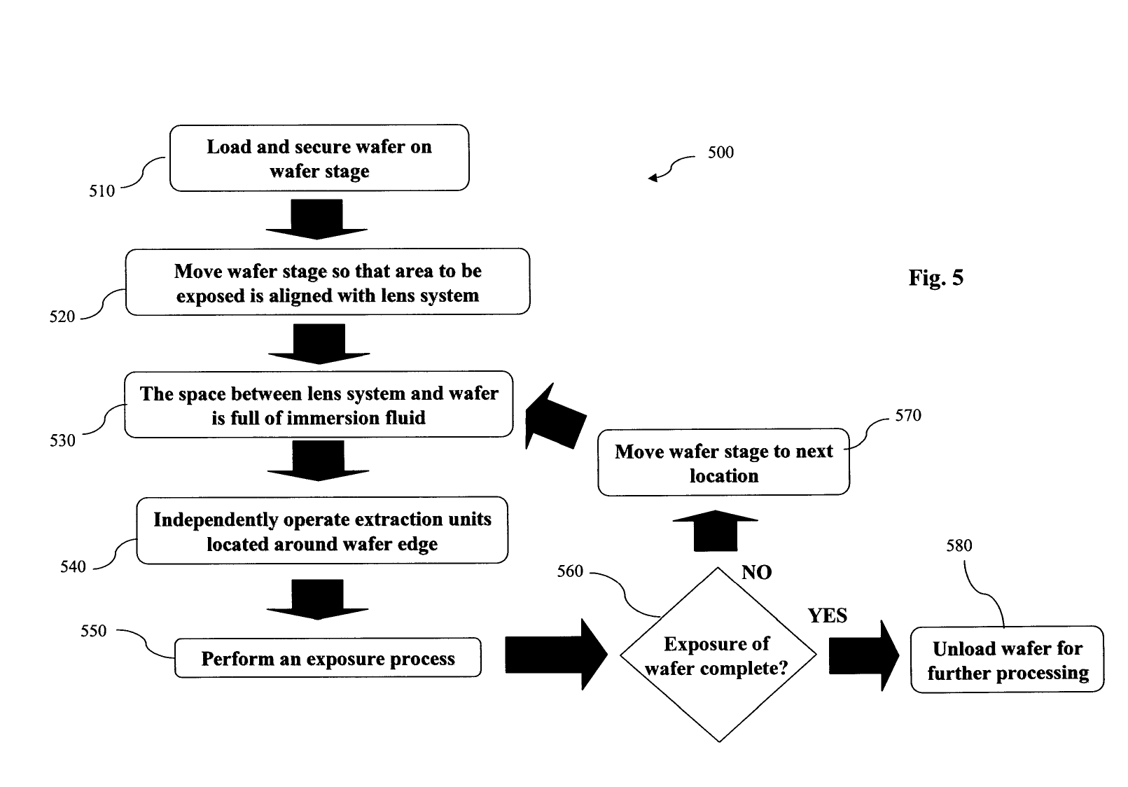

Referring now to FIG. 5, illustrated is a flowchart of an immersion lithography method 500 according to one or more embodiments of the present disclosure. The method 500 may be implemented in the immersion lithography system 400 of FIGS. 4A and 4B. The method 500 begins with step 510 in which a wafer may be loaded and secured on a wafer stage via a vacuum chuck. The wafer stage may be disposed beneath an immersion hood. The wafer may include a photoresist layer ready for patterning. The method 500 continues with step 520 in which the wafer stage may be moved a first location so that an area of the photoresist layer to be exposed may be aligned with the lens system of the immersion hood.

The method 500 continues with step 530 in which an immersion fluid may be provided to a space between the lens system and the wafer. It is understood that the immersion fluid may be provided at a substantially constant rate. The immersion fluid may be removed from the space by a drain system including outlets located with the immersion hood. The method 500 continues with step 540 in which a plurality of extraction units positioned around an edge of the wafer may be independently operated by a controller. The controller may control the extraction units according to a recipe setting such that the extraction unit may be turned on when the immersion fluid covers the edge of the wafer that is proximate to that extraction unit, and the extraction unit may be turned off when the immersion fluid does not cover the edge of the wafer that is proximate to that extraction unit.

The method 500 continues with step 550 in which an exposure process may be performed on the area of the photoresist layer to form a pattern. The exposure process may include exposing the area with a radiation source through a photomask to transfer a pattern to the photoresist. The method 500 continues with step 560 in which a decision may be made as to whether exposure of the entire wafer has been completed.

If the answer is no, the method 500 continues with step 570 in which the wafer stage may be moved to a next location and the method repeats steps 530 through 560. If the answer is yes, the method 500 continues with step 580 in which the wafer may be unloaded from the immersion lithography system 400. The exposed photoresist layer may go through further processing steps such as a post-exposure bake process and a development process to form a patterned photoresist layer. These processes are known in the art and thus, are not described in detail here.

Although only a few exemplary embodiments have been described in detail above, those skilled in the art will readily appreciate that many modifications are possible in the exemplary embodiments without materially departing from the novel teachings and advantages of this invention. It is understood that the present disclosure is not limited to immersion lithography, but immersion lithography provides an example of a semiconductor process that can benefit from the invention described in greater detail below.

It is understood that various different combinations of the above-listed embodiments and steps can be used in various sequences or in parallel, and there is no particular step that is critical or required. Furthermore, features illustrated and discussed above with respect to some embodiments can be combined with features illustrated and discussed above with respect to other embodiments. Accordingly, all such modifications are intended to be included within the scope of this disclosure.

Thus, the present disclosure provides an immersion lithography apparatus including a lens assembly having an imaging lens, a wafer stage for securing a wafer beneath the lens assembly, a fluid module for providing a fluid into a space between the lens assembly and the wafer, and a plurality of extraction units positioned proximate to an edge of the wafer. The plurality of extraction units are configured to operate independently to remove a portion of the fluid provided into the space between the lens assembly and the wafer. In some embodiments, each of the plurality of extraction units includes a suck back line. In some other embodiments, the suck back line is controlled by a valve. In other embodiments, the valve is configured to be turned on when the edge of the wafer that is proximate to the suck back line is covered with the fluid. In still other embodiments, the valve is configured to turn off when the edge of the wafer that is proximate to the suck back line is free of the fluid.

In some other embodiments, some of the plurality of extraction units that are in close proximity of each other share a valve. In other embodiments, the plurality of extraction units are integral with the wafer stage. In some other embodiments, the plurality of extraction units are uniformly positioned around the edge of the wafer.

Additionally, an immersion lithography method is provided which includes the steps of loading and securing a wafer onto a wafer stage disposed beneath an imaging lens; moving the wafer stage so that an area of the wafer to be exposed is aligned with the imaging lens; providing a fluid into a space between the imaging lens and the wafer; performing an exposure process to the area of the wafer; independently operating a plurality of extraction units located proximate to an edge of the wafer to remove a portion of the fluid provided into the space between the imaging lens and the wafer; and moving the wafer stage to a next location and repeating some of the previous steps until exposure of the entire wafer is complete. In some embodiments, the step of independently operating the plurality of extraction units includes providing a valve for each of the plurality of extraction units.

In other embodiments, the step of independently operating the plurality of extraction units includes turning on the valve when an edge of the wafer that is proximate to the corresponding extraction unit is covered with the fluid and turning off the valve when the edge of the wafer that is proximate to the corresponding extraction unit is free of the fluid. In other embodiments, the step of independently operating the plurality of extraction units includes controlling the valve according to a recipe setting. In some other embodiments, the step of independently operating the plurality of extraction units includes providing a valve for some of the plurality of extraction units that are in close proximity of each other. In other embodiments, the method further includes the steps of providing a wafer having a photoresist layer formed thereon, performing a post-exposure bake on the exposed photoresist layer, and developing the exposed photoresist layer to form a patterned photoresist layer. In still other embodiments, the step of independently operating the plurality of extraction units includes integrating the plurality of extraction units with the wafer stage.

Also provided is an immersion lithography system including an imaging lens module; a substrate table positioned beneath the imaging lens module and configured to hold a substrate; a fluid retaining module for providing a fluid into a space between the imaging lens module and the substrate on the substrate table; a plurality of extraction lines disposed around an edge of the substrate, wherein each extraction line includes a valve; and a controller for independently controlling the valve of each of the plurality of extraction lines to remove the fluid provided into the space between the imaging lens module and the substrate on the substrate table. In some embodiments, the controller is configured to turn on the valve when an edge of the substrate that is proximate to the corresponding extraction line is covered with the fluid and turn off the valve when the edge of the substrate that is proximate to the corresponding extraction line is free of the fluid. In other embodiments, each extraction line includes a fluid suck back force. In some other embodiments, the extraction lines are incorporated with the substrate table. In still other embodiments, the extraction lines are uniformly spaced around the edge of the substrate.

Several advantages exist with these and other embodiments of the present disclosure. In addition to providing a simple and cost-effective apparatus and method for minimizing a temperature variance of a surface of a wafer in immersion lithography, the apparatus and method may be integrated with current semiconductor processing equipment and techniques. By maintaining a substantially uniform temperature on an imaging layer, complex compensation techniques via sensors and tools in focusing the lens system may be eliminated. Therefore, critical dimensions and profiles of features patterned on the imaging layer may be consistent at all locations on the wafer.

What is claimed is:

1. An immersion lithography apparatus comprising:
a lens assembly including an imaging lens;
a wafer stage for securing a wafer beneath the lens assembly;
a fluid module for providing a fluid to a space between the lens assembly and the wafer; and
a plurality of extraction units positioned proximate to an edge of the wafer, wherein the plurality of extraction units are configured to operate independently to remove a portion of the fluid provided to the space between the lens assembly and the wafer.

2. The apparatus of claim 1, wherein each of the plurality extraction units includes a suck back line.

3. The apparatus of claim 2, wherein the suck back line is controlled by a valve.

4. The apparatus of claim 3, wherein the valve is configured to be turned on when the edge of the wafer that is proximate to the suck back line is covered with the fluid.

5. The apparatus of claim 3, wherein the valve is configured to be turned off when the edge of the wafer that is proximate to the suck back line is free of the fluid.

6. The apparatus of claim 1, wherein some of the plurality of extraction units that are in close proximity of each other share a valve.

7. The apparatus of claim 1, wherein the plurality of extraction units are integral with the wafer stage.

8. The apparatus of claim 7, wherein the plurality of extraction units are uniformly positioned around the edge of the wafer.

9. An immersion lithography method, comprising:
loading and securing a wafer onto a wafer stage disposed beneath an imaging lens;
moving the wafer stage so that an area of the wafer to be exposed is aligned with the imaging lens;
providing a fluid into a space between the imaging lens and the wafer;
performing an exposure process to the area of the wafer;
independently operating a plurality of extraction units located proximate to an edge of the wafer to remove a portion of the fluid provided into the space between the imaging lens and the wafer; and
moving the wafer stage to a next location and repeating some of the previous steps until exposure of the entire wafer is complete.

10. The method of claim 10, wherein the step of independently operating the plurality of extraction units includes providing a valve for each of the at least two extraction units.

11. The method of claim 11, wherein the step of independently operating the plurality of extraction units includes:
turning on the valve when an edge of the wafer that is proximate to the corresponding extraction unit is covered with the fluid; and
turning off the valve when the edge of the wafer that is proximate to the corresponding extraction unit is free of the fluid.

12. The method of claim 11, wherein the step of independently operating the plurality of extraction units includes controlling the valve according to a recipe setting.

13. The method of claim 10, wherein the step of independently operating the plurality extraction units includes providing a valve for some of the plurality of extraction units that are in close proximity of each other.

14. The method of claim 10, further comprising the steps of:
providing a wafer having a photoresist layer formed thereon;
performing a post-exposure bake on the exposed photoresist layer; and
developing the exposed photoresist layer to form a patterned photoresist layer.

15. The method of claim 10, wherein the step of independently operating the plurality of extraction units includes integrating the plurality of extraction units with the wafer stage.

16. An immersion lithography system, comprising:
an imaging lens module;
a substrate table positioned beneath the imaging lens module and configured to hold a substrate;
a fluid retaining module for providing a fluid into a space between the imaging lens module and the substrate on the substrate table;
a plurality of extraction lines disposed around an edge of the substrate, wherein each of the plurality of extraction lines includes a valve; and
a controller for independently controlling the valve of each of the plurality of extraction lines to remove the fluid provided into the space between the imaging lens module and the substrate.

17. The system of claim 16, wherein the controller is configured to turn on the valve when an edge of the substrate that is proximate to the corresponding extraction line is covered with the fluid and turn off the valve when the edge of the substrate that is proximate to the corresponding extraction line is free of the fluid.

18. The system of claim 17, wherein each of the plurality of extraction lines includes a fluid suck back force.

19. The system of claim 17, wherein the plurality of extraction lines are incorporated with the substrate table.

20. The system of claim 17, wherein the plurality of extraction lines are uniformly spaced around the edge of the substrate.
